(19) United States
(12) Patent Application Publication
(10) Pub. No.: US 2002/0073030 A1
(43) Pub. Date: Jun. 13, 2002

(54) Configuration and method for increasing the prepaid amount associated with an electronic prepaid account

(76) Inventor: Gero Offer, Gartingen (DE)

Correspondence Address: LERNER AND GREENBERG, P.A., PATENT ATTORNEYS AND ATTORNEYS AT LAW, POST OFFICE BOX 2480, HOLLYWOOD, FL, 33020, US

(21) Appl. No.: 09/997,049

(22) Filed: Nov. 20, 2001

(30) Foreign Application Priority Data
Nov. 20, 2000 (DE) 100 57 496.3
Feb. 1, 2001 (DE) 101 04 540.9

(51) Int. Cl. G06F 17/60

(52) U.S. Cl. 705/41

(57) ABSTRACT

A configuration and a method is disclosed that allows the owner of an electronic prepaid account to increase the prepaid amount that is associated with the electronic prepaid account by paying an amount in cash in conjunction with an access software reading procedure. The access software that is generated, is preferably configured on an access card, and is read by a non-specialized card reader of a card payment system. The prepaid account is increased in an amount corresponding to the cash payment. The prepaid account is preferably an account for telecommunication services.

### BACKGROUND OF THE INVENTION

1. Field of the Invention

The invention relates to a configuration and to a method for allowing the owner of an electronic prepaid account to increase the prepaid amount associated with the electronic prepaid account.

Prepaid accounts are quickly gaining importance in conjunction with the provision of and the payment for telecommunications services, and in particular, are gaining importance within the scope of mobile telecommunications, which are developing dynamically. They constitute an essential instrument for acquiring customers who use the respective services less frequently, and are therefore, particularly interested in tariffs that are have low fixed charges or that have no fixed charges.

Basically, prepaid accounts are, however, also suitable for paying for other types of services or even for goods—specifically within the framework of trader-customer relations which have been in existence for a long time, and in this context, in particular, for delivery and payment relations during which very small amounts frequently have to be settled.

Whereas fixed amounts of credit were stored electronically in cards at the beginning of the practice of prepaid accounts and the user had to acquire a new card after the credit was used, for several years now there have also been cards onto which additional amounts can be loaded or authorized electronically. Although these cards have proven themselves suitable for a large number of applications of prepaid accounts, the outlay required by the user to load additional amounts onto the account has given impetus to a search for simpler ways of operating prepaid accounts.

Basically methods for generating and transmitting vouchers and bank collection are applied here in practical terms. The first method is associated with a high degree of organizational and logistical expenditure on the part of the operator and with correspondingly high distribution costs. The latter method operates with a certain delay and is therefore associated with an invoice risk. In addition, the rights of the customer (owner of the account) to cancel which are inherent in any direct debiting service are to a certain degree an impediment for a simple and smoothly running procedure.

### SUMMARY OF THE INVENTION

It is accordingly an object of the invention to provide a configuration and a method for operating an electronic prepaid account, which overcome the above-mentioned disadvantages of the prior art configurations and methods of this general type. In particular, it is an object of the invention to provide a simple and cost-effective method for increasing the prepaid amount associated with an electronic prepaid account.

With the foregoing and other objects in view there is provided, in accordance with the invention, a method for increasing a prepaid amount associated with an electronic prepaid account, that includes steps of: generating, by an operator of a prepaid account, access software that can be read by a non-specialized card reader of a card payment system; reading the access software with the card reader in conjunction with receiving an amount in cash from the owner of the prepaid account; transferring identification data of the owner of the prepaid account together with a value of the amount to an account server holding the prepaid account; and increasing, by the value of the amount, a prepaid amount that is associated with the prepaid account.

In accordance with an added mode of the invention, the method includes associating the prepaid account with telecommunications services such that when the telecommunications services are performed, the prepaid account will be debited.

In accordance with an additional mode of the invention, the method includes transferring the identification data and the value of the amount to the account server; and processing the identification data and the value of the amount in the account server essentially in real time.

In accordance with another mode of the invention, the method includes, with the account server, checking the identification data and generating an electronic paid-in receipt; transmitting the electronic paid-in receipt to the card reader; and with the card reader, performing an operation selected from the group consisting of displaying the receipt, storing the receipt, and printing the receipt.

In accordance with an further mode of the invention, the method performing the checking and generating step in essentially real time.

In accordance with yet an added mode of the invention, the method includes, with the card reader, printing out a first copy of the receipt for the owner of the prepaid account and a second copy of the receipt for an operator of the card reader.

In accordance with yet an additional mode of the invention, the method includes transferring the identification data and the value of the amount to the account server via a public telecommunications network.

In accordance with yet another mode of the invention, the method includes providing the identification data with an identifier for a service that the prepaid account is used to pay for.

In accordance with yet a further mode of the invention, the method includes providing the identification data with a call number of a telecommunications network that is used by the owner of the prepaid account.

In accordance with a further added mode of the invention, the method includes manually inputting further data in conjunction with the step of reading the access software.

In accordance with a further additional mode of the invention, the further data is selected from the group consisting of a call number of a telecommunications network used by the owner of the prepaid account and authentication data of the owner.

In accordance with another mode of the invention, the method includes, with a gateway server of the card payment system, checking the identification data and evaluating the value of the amount; depending on a result of the checking and evaluating, generating a collection signal for collecting the value of the amount in favor of the operator of the prepaid account; and transferring the collection signal to a third-party bank server that is responsible for clearing the value of the amount.

In accordance with a further mode of the invention, the method includes providing the access software on an access card.

With the foregoing and other objects in view there is provided, in accordance with the invention, a configuration for allowing an owner of an electronic account to increase a prepaid amount associated with the electronic account. The configuration includes: a non-specialized card reader unit designed to read in cards selected from the group consisting of conventional prepaid cards and conventional credit cards, the card reader unit designed for inputting a paid-in amount; an account server for administering a prepaid account; a communication link between the card reader and the account server, the communication link selected from the group consisting of a telecommunications link and a data link; and a carrier having an access software product that can be read by the card reader. The account server includes a receiving and processing unit designed to receive the paid-in amount that is input at the card reader. The receiving and processing unit is also designed to receive identification data selected from the group consisting of data that is read by the card reader unit and data that is input manually.

In accordance with an added feature of the invention, the carrier is an access card.

In accordance with an additional feature of the invention, there is provided, a gateway server. The account server has a receipt transmitting unit designed to transmit an electronic paid-in receipt to the card reader unit via the gate way server.

In accordance with another feature of the invention, the communications link is a public telecommunications network connecting the card reader unit and the gateway server to the account server.

In accordance with a further feature of the invention, the communications link is a public telecommunications network connecting the card reader unit to the account server.

In accordance with a further added feature of the invention, there is provided, a gateway server having a collection signal transmitting unit for generating a collection signal; and a third-party bank server. The gateway server has means for setting up an at least temporary connection to the third-party bank server for transmitting the collection signal to the bank server.

In accordance with another added feature of the invention, the card reader unit is formed in a device selected from the group consisting of a cash system and an internet-capable PC.

The invention includes the essential idea of using a proven card reading system, which is known per se, for loading an additional amount to a prepaid account. It also includes the idea of using this card reading system in a configuration in which the owner of the prepaid account makes a cash payment in conjunction with using software or an access card which permits access to the prepaid system.

The essential advantages of the invention include the fact that a system which has been proven for a long time and is widely distributed can be used for handling prepaid accounts so that the organizational and cost outlay for generating the system can be kept extremely low. Furthermore, the many years of experience with a wide range of user groups and the high degree of user acceptance of the proven card reader systems are of great advantage for rapid and easy market penetration. Finally, the established high security standards for using the proven system—the security requirements for the handling of a prepaid account with respect to loading credit on to it can be significantly less stringent than those that need to be met by a credit card system. The generation and administration of access cards that are associated with prepaid accounts can be configured in a correspondingly simpler and more cost-effective way.

According to one expedient implementation of the idea of the invention, the data stored in the card is transferred, after reading the data in real time, to the account server and is processed there. As a result, it is possible, in particular to achieve the effect that both the users and the personnel who are active in conjunction with the cash payment and the reading of the authorization card are informed immediately of the success of the transaction. The absence of any delay in the technical processing of data is also advantageous and enables problems to be avoided in the administration of the account even when loading-up and debiting procedures are being carried out in rapid succession.

The aforesaid advantage comes into play if, as a result of the checking and processing of the identification data by the account server of the prepaid account, an electronic paid-in receipt is generated, transmitted to the card reader and displayed there or printed out, also essentially in real time.

In the case of a print-out, two receipt copies are preferably printed out, one of which serves as a payment receipt for the owner of the account and the other as a transaction receipt within the framework of the operation of the card reader system.

In an embodiment which is particularly easy to install, the transmission, from the paying-in point, of the software or the data read out from the access card and of the paid-in amount, and the transmission, to the paying-in point, of the optionally generated paid-in receipt, takes place via a public telecommunications network, in particular the telephone fixed network. Here, the implementation and operating costs are very low, and nevertheless the availability is sufficiently high.

In a first organizational refinement of the proposed method, the software which is stored in an access card in one preferred embodiment is made available to the operator of the card reader device (trader) directly by the operator of the prepaid system. It is then nonspecific with regard to individual account owners and merely ensures access to the prepaid system. This has the advantage that the person making the payment would not need to carry a card on them. The authorized trader would administer these system access cards.

In another embodiment, individual access cards are generated for the individual users of the prepaid system and are issued to them—which appears appropriate in particular in conjunction with a wider card system (credit or customer cards). In both cases, not only the actual access software but also specific data are read in or loaded onto the card reader device. This data includes, in particular, an identifier of a specific service performance (or of a multiplicity of service performances) which the prepaid account is used to pay for. These can be in particular telecommunications services, in which case, in the case of a user-specific access card, the identification data includes the call number of a terminal of the telecommunications network which is used by the owner of the prepaid account.

In an alternative refinement of the system, a corresponding identifier—that is to say for example the aforementioned call number—can be input “manually” in conjunction with the paying-in procedure while the authorization card contains essentially only data for a system access to the system of the operator of the prepaid account (and provider of the service performances which are paid for with it). Combined methods (and corresponding embodiments of the access card) are possible in which a portion of the relevant, in particular service-performance-specific or use-specific data is read out of the card and another portion is input in conjunction with the reading operation at the reading device. Furthermore, it also appears possible to expand the software of the reading devices in such a way that, for example, only the telephone number and the amount are to be input.

In the context of completely automating the loading up of the prepaid account, paying in can also be carried out on a coin-operated or bill-operated automatic machine, such as is used, and has gained acceptance, in local transport systems and parking systems. Here, the paid-in amount is determined automatically when the coins or bills are introduced into the automatic device and is transferred automatically to the account server of the prepaid account together with the other data (manual input or by magnetic card).

In order to implement a transaction which has been concluded, the account server checks the data obtained from the paying-in point. As a result of the check, a collection signal is expediently transferred, for the collection of the paid-in amount, to the bank server of the card-reading operator (trader) to which the card reader belongs. The implementation of this embodiment requires, of course, a contractual provision between the operator of the card reading system, the bank via which its billings are processed, and the operator of the prepaid account.

An arrangement for carrying out the method explained above includes the card reader, which is known per se, the customary telecommunications or data connection to the latter, an account server that is embodied for communication with the card reader and that administers the prepaid account, and an authorization card of the operator of the prepaid account. The card is designed to be read by the card reader.

The account server has, in particular, a receiving and processing unit which is designed to receive and process data which is read out from the authorization card by the card reader and/or input into it. In one advantageous embodiment the account server additionally has a receipt transmitting unit which generates a receipt data record relating to the completed transaction (loading up of the prepaid credit). The receipt transmitting unit transfers the data record to the card reader, and this record is received and evaluated by the card reader.

In a further preferred embodiment, the account server has a collection signal transmitting unit and at least at certain times a data connection to an external bank server on which the transactions that are processed in the card reading system are administered, in order to implement a collection of the paid-in amount from the account of the card reading operator in favor of the operator of the prepaid account.

Other features which are considered as characteristic for the invention are set forth in the appended claims.

Although the invention is illustrated and described herein as embodied in a method for operating an electronic prepaid account and arrangement for implementing it, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows an exemplary configuration illustrating a method for increasing the amount associated with a prepaid account; and

FIG. 2 is a block circuit diagram showing the essential functional components of a configuration for increasing the amount associated with a prepaid account.

### DESCRIPTION OF THE PREFERRED EMBODIMENTS

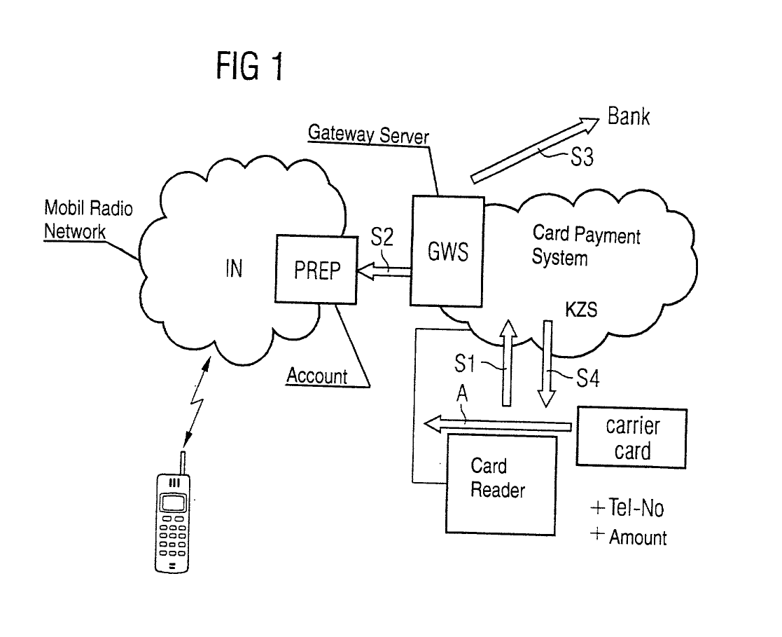

Referring now to the figures of the drawing in detail and first, particularly, to FIG. 1 thereof, there is shown a card reader connected to a card payment system KZS. A gateway server GWS is connected between the card payment system KZS and a mobile radio network IN that is embodied as an intelligent network. A prepaid account PREP is reloaded via the card reader in order to use telecommunications services of the mobile radio network IN. In an inputting procedure A, a carrier card authorization card is drawn through the card reader and the telephone number of the line of the user of the mobile radio network and the prepaid account as well as a simultaneously paid-in amount of money are input manually. The data which is read in or input is transmitted to the card payment system KZS in a first data transmission step S1.

In a step S2, the paid-in amount is credited to the prepaid account PREP. After the crediting process has taken place, in a third step S3 an electronic transfer or collection of the paid-in amount is controlled by the bank of the card reading operator in favor of the operator of the mobile radio network IN. In a step S4, a receipt (in duplicate) for the paying-in party and the personnel of the card payment system is finally output at the card reader. In a last step (not illustrated), the card reading operator manually places the money in his cash desk.

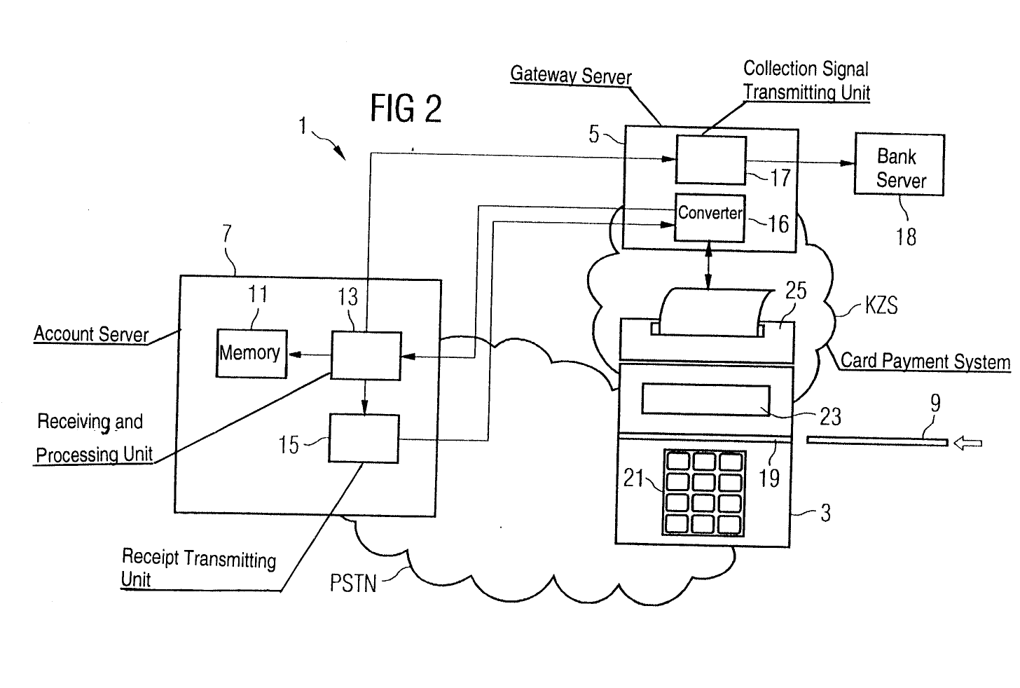

FIG. 2 shows somewhat more precisely the structure of a corresponding prepaid loading-up arrangement 1 from functional points of view. The prepaid loading-up arrangement 1 includes a card reader 3 which is connected to a gateway server 5 in the card payment system KZS already mentioned, an account server 7, which is temporarily connected to the gateway server 5 via a line of a public telephone fixed network PSTN, and an authorization card 9 of the operator of the prepaid account.

The account server 7 includes the actual credit memory 11, in which the prepaid account of a user is stored, a receiving and processing unit 13 for data which is transferred by the gateway server 5, and a receipt transmitting unit 15. The receiving and processing unit 13 has an input connected to the output of the gateway server 5, while the receipt transmitting unit 15 has an output connected to a corresponding input of the gateway server 5.

The gateway server 5 has a processor/protocol converter 16 for ensuring communication with the card reader 3 and the account server 7. The gateway server 5 also has a collection signal transmitting unit 17 for the “banking” processing of the payment settlement between the money receiver of the cash payment, specified by the card payment system, and the operator of the prepaid system (specifically mobile radio system). The collection system transmitting unit 17 of the gateway server 5 has an input, connected to the receiving and processing unit 13 of the account server 7, and an output connected to an input of a bank server 18.

The card reader 3 has a card slot 19 with an associated reading unit (not depicted), an input keypad 21, a visual display unit 23 and a receipt printer 25. After the authorization card 9 has been introduced into the card slot 19, data which is stored in the card and which relates to the prepaid system, and if appropriate, identification data relating to the service performances linked to the prepaid account and/or data relating to the user and/or to the prepaid account operator are read out. In parallel with this reading operation, an amount of money is paid in order to load up the prepaid account in the credit memory 11 of the account server 7, and the amount is manually input by means of the input keypad 21.

The data which is read in or input is fed to the processor/protocol converter 16 of the gateway server 5. The latter determines the associated prepaid account server 7 and sets up a connection to its receiving and processing unit 13 where the data is checked and processed. As a result of the checking and processing, assumed to be a positive result here, the memory state of the credit memory 11 is increased by the paid-in amount, an electronic receipt is transferred to the gateway server 5 via the receipt transmitting unit 15 and in addition a collection of the amount in favor of the operator of the prepaid account via the bank server 5 is additionally brought about by means of the collection signal transmitting unit 17 of the gateway server 5. (In the case of a negative check result, the transaction is of course not carried out).

Of course, the functional components of the account server 7 which are mentioned here can be implemented in hardware terms and software terms and in particular in a combination of hardware and software components.

The embodiment of the invention is not restricted to the example outlined above but is likewise possible in a multiplicity of refinements which lie within the scope of the activity of a person skilled in the art. In particular, the invention is possible using a customer card system instead of an ordinary card payment system (as mentioned above), or with combined automatic card and cash machines in which it is not necessary to input the amount of money because the amount is determined automatically.

Furthermore, it is to be noted that of course one advantageous embodiment includes, instead of physical card readers, implementing the card readers so that they are integrated into cash desks and/or implemented logically into internet-capable PCs (and then also menu-prompted instead of having a card reading device).

I claim:

1. A method for increasing a prepaid amount associated with an electronic prepaid account, which comprises:
generating, by an operator of a prepaid account, access software that can be read by a non-specialized card reader of a card payment system;
reading the access software with the card reader in conjunction with receiving an amount in cash from the owner of the prepaid account;
transferring identification data of the owner of the prepaid account together with a value of the amount to an account server holding the prepaid account; and
increasing, by the value of the amount, a prepaid amount that is associated with the prepaid account.

2. The method according to claim 1, which comprises associating the prepaid account with telecommunications services such that when the telecommunications services are performed, the prepaid account will be debited.

3. The method according to claim 1, which comprises: transferring the identification data and the value of the amount to the account server; and
processing the identification data and the value of the amount in the account server essentially in real time.

4. The method according to claim 1, which comprises:
with the account server, checking the identification data and generating an electronic paid-in receipt;
transmitting the electronic paid-in receipt to the card reader; and
with the card reader, performing an operation selected from the group consisting of displaying the receipt, storing the receipt, and printing the receipt.

5. The method according to claim 4, which comprises performing the checking and generating step in essentially real time.

6. The method according to claim 4, which comprises, with the card reader, printing out a first copy of the receipt for the owner of the prepaid account and a second copy of the receipt for an operator of the card reader.

7. The method according to claim 1, which comprises:
transferring the identification data and the value of the amount to the account server via a public telecommunications network.

8. The method according to claim 1, which comprises:
providing the identification data with an identifier for a service that the prepaid account is used to pay for.

9. The method according to claim 8, which comprises:
providing the identification data with a call number of a telecommunications network that is used by the owner of the prepaid account.

10. The method according to claim 1, which comprises:
manually inputting further data in conjunction with the step of reading the access software.

11. The method according to claim 10, wherein the further data is selected from the group consisting of a call number of a telecommunications network used by the owner of the prepaid account and authentication data of the owner.

12. The method according to claim 1, which comprises:
with a gateway server of the card payment system, checking the identification data and evaluating the value of the amount;
depending on a result of the checking and evaluating, generating a collection signal for collecting the value of the amount in favor of the operator of the prepaid account; and
transferring the collection signal to a third-party bank server that is responsible for clearing the value of the amount.

13. The method according to claim 1, which comprises providing the access software on an access card.

14. A configuration for allowing an owner of an electronic account to increase a prepaid amount associated with the electronic account, comprising:
a non-specialized card reader unit designed to read in cards selected from the group consisting of conventional prepaid cards and conventional credit cards, said card reader unit designed for inputting a paid-in amount;
an account server for administering a prepaid account;
a communication link between said card reader and said account server, said communication link selected from the group consisting of a telecommunications link and a data link;
a carrier having an access software product that can be read by said card reader;
said account server including a receiving and processing unit designed to receive the paid-in amount that is input at said card reader;
said receiving and processing unit also designed to receive identification data selected from the group consisting of data that is read by said card reader unit and data that is input manually.

15. The configuration according to claim 14, wherein said carrier is an access card.

16. The configuration according to claim 14, comprising:
a gateway server;
said account server having a receipt transmitting unit designed to transmit an electronic paid-in receipt to said card reader unit via said gate way server.

17. The configuration according to claim 16, wherein:
said communications link is a public telecommunications network connecting said card reader unit and said gateway server to said account server.

18. The configuration according to claim 14, wherein said communications link is a public telecommunications network connecting said card reader unit to said account server.

19. The configuration according to claim 14, comprising:
a gateway server having a collection signal transmitting unit for generating a collection signal; and
a third-party bank server;
said gateway server having means for setting up an at least temporary connection to said third-party bank server for transmitting the collection signal to said bank server.

20. The configuration according to claim 14, wherein said card reader unit is formed in a device selected from the group consisting of a cash system and an internet-capable PC.
